(19) United States
(12) Patent Application Publication
(10) Pub. No.: US 2008/0297701 A1
(43) Pub. Date: Dec. 4, 2008

(54) Backlight Assembly, Display Apparatus Having the Same and Method for Manufacturing the Same

(75) Inventors: Kwang-Hee Lee, Seoul (KR); Seong-Sik Choi, Cheonan-si (KR); Han-Jin Ryu, Seongnam-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/056,397

(22) Filed: Mar. 27, 2008

(30) Foreign Application Priority Data
Mar. 28, 2007 (KR) 1020070030148

(51) Int. Cl. G02F 1/13357; F21V 19/00; H01J 9/24; H05B 33/02

(52) U.S. Cl. 349/68; 362/249; 362/231; 445/29

(57) ABSTRACT

In a backlight assembly, a display apparatus and a method thereof, the backlight assembly includes a base substrate, a plurality of point light sources, a receiving container and a converter. The base substrate includes a first connector electrically connected to the base substrate at a lower surface of the base substrate. The receiving container includes a side wall and a bottom plate, and receives the base substrate. The bottom plate faces the lower surface of the base substrate and includes an opening into which the first connector is inserted. The converter is disposed on an opposite side of the bottom plate of the receiving container from the base substrate and includes a second connector electrically connected to the converter at an upper surface of the converter. The second connector is separably connected to the first connector.

This application claims priority to Korean Patent Application No. 2007-30148, filed on Mar. 28, 2007, and all the benefits accruing therefrom under 35 U.S.C. § 119, the contents of which are herein incorporated by reference in their entirety.

### BACKGROUND OF THE INVENTION

1. Field of the Invention

The present invention relates to a backlight assembly. More particularly, the present invention relates to the backlight assembly having a simple assembly process, a display apparatus having the backlight assembly, and a method for manufacturing the backlight assembly.

2. Description of the Related Art

A flat display apparatus having a relatively small size and a light weight is often used as a display apparatus. Particularly, a liquid crystal display (“LCD”) apparatus displaying images by using liquid crystal is widely used. The LCD apparatus includes an LCD panel that does not emit light by itself, and thus the LCD apparatus requires a backlight assembly that provides the light to the LCD panel. Particularly, the backlight assembly used for a compact product may include a light-emitting diode (“LED”) having a small size as a light source.

The backlight assembly may be classified as either a direct-illumination type or an edge-illumination type. The direct-illumination type backlight assembly includes a light source such as the LED, a printed circuit board (“PCB”) on which the light source is mounted, a diffusion plate diffusing light emitted from the light source to the LCD panel, a receiving container disposed under the PCB and the diffusion plate, to receive the PCB and the diffusion plate, and a driving converter disposed under the receiving container to provide a driving power.

The PCB and the driving converter may be connected with each other through a connector and a connecting cable. However, the connection using the connecting cable makes a structure of the backlight assembly complicated. Thus, the backlight assembly may be fabricated by a complicated assembly process and have less durability, and manufacturing costs may be increased.

### BRIEF SUMMARY OF THE INVENTION

An exemplary embodiment provides a backlight assembly simplifying a manufacturing process and decreasing manufacturing costs.

An exemplary embodiment provides a display apparatus having the backlight assembly.

An exemplary embodiment provides a method for manufacturing the backlight assembly.

In an exemplary embodiment of a backlight assembly, the backlight assembly includes a base substrate, a plurality of point light sources, a receiving container and a converter. The base substrate includes a first connector electrically connected to the base substrate at a lower surface of the base substrate. The plurality of point light sources is mounted on the base substrate. The receiving container includes a side wall and a bottom plate, and receives the base substrate. The bottom plate faces the lower surface of the base substrate and includes an opening into which the first connector is inserted. The converter is disposed on an opposite side of the bottom plate of the receiving container from the base substrate and includes a second connector electrically connected to the converter at an upper surface of the converter. The second connector is separably connected to the first connector. The first connector is directly and electrically connected to the second connector through the opening of the receiving container.

In an exemplary embodiment of a backlight assembly, the backlight assembly includes a plurality of base substrates, a plurality of point light sources, a receiving container and a converter. The base substrates are arranged substantially in parallel to each other. Each of the base substrates includes a first connector electrically connected to the base substrate at a lower surface of the base substrate. The point light sources are mounted on each of the base substrates. The receiving container includes a side wall and a bottom plate, and receives the base substrates. The bottom plate faces the lower surfaces of the base substrates and includes a plurality of openings. Each of the openings corresponds to a first connector. The converter is disposed on an opposite side of the bottom plate of the receiving container from the base substrates and includes a plurality of second connectors electrically connected to the converter at an upper surface of the converter. Each of the second connectors corresponds to a first connector and an opening. Each of the first connectors passes through the opening corresponding to the first connector, and is directly and electrically connected to the second connector.

In an exemplary embodiment of a display apparatus, the display apparatus includes a backlight assembly and a display panel. The backlight assembly includes a base substrate, a receiving container and a converter. The base substrate includes a first connector electrically connected to the base substrate at a lower surface of the base substrate. The receiving container includes a side wall and a bottom plate. The bottom plate faces the lower surface of the base substrate and includes an opening corresponding to the first connector. The converter is disposed on an opposite side of the bottom plate of the receiving container from the base substrate and includes a second connector electrically connected to an upper surface of the converter. The second connector corresponds to the first connector and the opening. The display panel is disposed facing an upper surface of the base substrate of the backlight assembly, and displays images using light passing through the backlight assembly.

In an exemplary embodiment of a method for manufacturing a backlight assembly, the method includes electrically connecting a first connector to a base substrate at a lower surface of the base substrate on which a plurality of point light sources is mounted. A receiving container includes a side wall, and a bottom plate including an opening. The bottom plate faces the lower surface of the base substrate, such that the opening corresponds to the first connector. A second connector is directly and electrically connected to an upper surface of a converter. The converter is disposed on an opposite side of the bottom plate of the receiving container from the base substrates, such that the second connector corresponds to the first connector and the opening. The method further includes directly and electrically connecting the first connector to the second connector through the opening.

As in an exemplary embodiment, a printed circuit board (“PCB”) is directly connected to the converter through the connector, without using a connecting line. Advantageously, a manufacturing process and external appearances may be simplified and manufacturing costs may be decreased.

In an exemplary embodiment, the PCB and/or the converter may be relatively easily replaced, and the durability of the display apparatus may be enhanced.

### BRIEF DESCRIPTION OF THE DRAWINGS

The above and other features and advantages of the present invention will become more apparent by describing in detailed example embodiments thereof with reference to the accompanying drawings, in which:

FIG. 1 is an exploded perspective view illustrating an exemplary embodiment of a display apparatus according to the present invention;

FIG. 2 is a cross-sectional view taken along line I-I′ of FIG. 1;

FIG. 3 is a plan view illustrating an exemplary embodiment of a printed circuit board (“PCB”) in FIG. 1;

FIG. 4 is a plan view illustrating an exemplary embodiment of a combined receiving container and a converter in FIG. 1;

FIG. 5 is a perspective view illustrating an exemplary embodiment of first and second connectors of the display apparatus in FIG. 1; and

FIG. 6 is an exploded perspective view illustrating another exemplary embodiment of a display apparatus according to the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” other elements or features would then be oriented “upper” the other elements or features. Thus, the term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

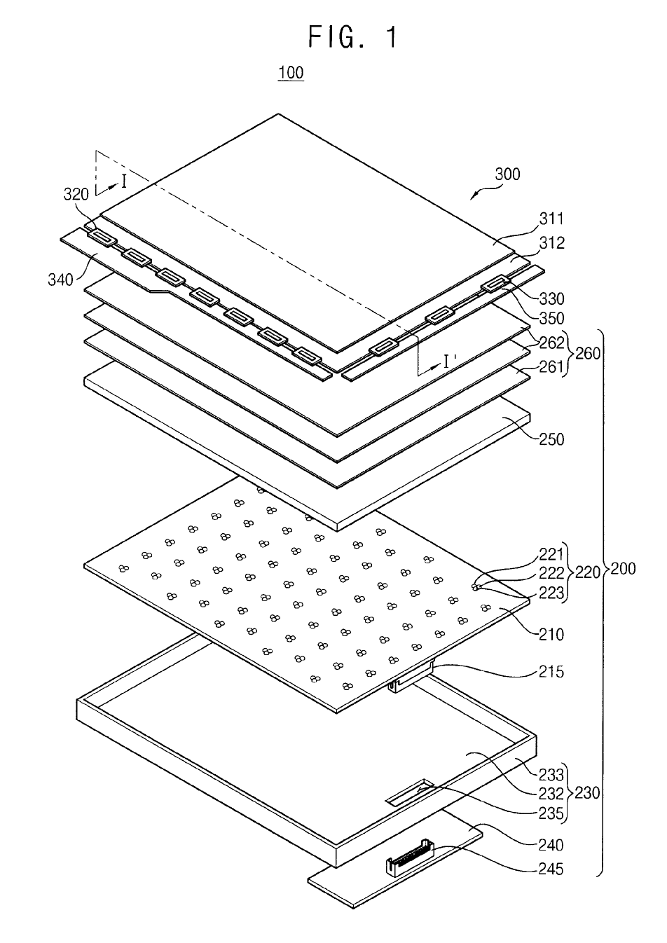

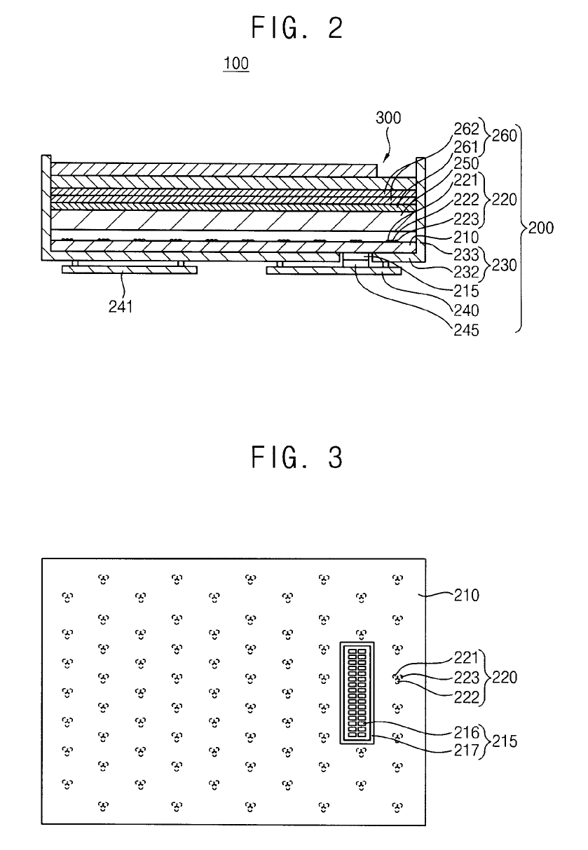

FIG. 1 is an exploded perspective view illustrating an exemplary embodiment of a display apparatus 100 according to the present invention. FIG. 2 is a cross-sectional view taken along line I-I′ of FIG. 1.

Referring to FIGS. 1 and 2, the display apparatus 100 includes a backlight assembly 200 and a display panel 300.

The backlight assembly 200 includes a base substrate 210, a plurality of sources 220, such as point light sources, a receiving container 230 and a converter 240.

The point light sources 220 are mounted on the base substrate 210, such as at an upper surface. A first connector 215 may be directly and electrically connected to the base substrate 210 at a lower surface of the base substrate 210, the lower surface opposite to the upper surface. In one exemplary embodiment, the base substrate 210 may be a printed circuit board (“PCB”). Where the base substrate 210 is a PCB, a control circuit that controls the point light sources may be printed on the base substrate 210.

The plurality of point light sources 220 (e.g., a group of individual or separate light sources) may be arranged substantially in a matrix shape, as illustrated in FIG. 1. Alternatively, the point light sources 220 may be arranged on an entire of the base substrate 210 in various locations, patterns and shapes. A number of the point light sources 220 disposed on the base substrate 210, and an arrangement distance between the point light sources 220 (e.g., between adjacent groups of individual light sources) are dependent on a size and a usage of the base substrate 210.

The first connector 215 may be directly and electrically connected to the base substrate 210 at the lower surface of the base substrate 210. As illustrated in FIG. 1, the first connector 215 may be connected adjacent to an edge (e.g. a side) of the base substrate 210, such as a transverse edge of the base substrate 210. When the first connector 215 is connected adjacent to the edge of the base substrate 210, a structure of the base substrate 210 may be simplified, and an assembly of the first connector 215 with the receiving container 230 and the converter 240 may be performed in a relatively easier process. Alternatively, the first connector 215 may be connected to a central portion of the base substrate 210, or in a location other than proximate to an edge of the base substrate. Additionally, a plurality of the first connectors 215 may be connected to both the central portion of the base substrate 210 and at a position adjacent to the edge of the base substrate 210.

In the illustrated embodiment, the first connector 215 is fixed extending substantially perpendicular to the base substrate 210. The first connector 215 may be arranged in any of a number of ways, including but not limited to substantially perpendicular, such that the first connector 215 may be combined with a second connector 245 of the converter 240.

The point light sources 220 are disposed on the base substrate 210, and are electrically connected to the base substrate 210. The point light sources 220 may include, but are not limited to, a light-emitting diode (“LED”) emitting white light. In an exemplary embodiment, the point light sources 220 may be turned to an “on” condition by a control signal from a control circuit of the base substrate 210, after the converter 240 provides power voltage to the point light sources 220.

In an exemplary embodiment, each of the point light sources 220 may include a red light source 221 emitting red light having a red wavelength, a green light source 222 emitting green light having a green wavelength and a blue light source 223 emitting blue light having a blue wavelength. Each of the red, green and blue light sources may be a red LED, a green LED and a blue LED, respectively. The red, green and blue LEDs may be formed as only one chip. When the red, green and blue LEDs are integrated into the one chip, e.g., forming a single chip, the red light, the green light and the blue light from the point light source 220 are mixed to emit the white light.

The number of the point light source 220 is determined by a size of the display panel 300 and brightness required of the display panel 300.

The receiving container 230 is disposed under the base substrate 210. The receiving container 230 includes a bottom plate 232 and a side wall 233. The bottom plate 232 has a substantially plate (or planar) shape, and is disposed substantially parallel with the base substrate 210. The bottom plate 232 faces the lower surface of the base substrate 210. The side wall 233 is disposed substantially perpendicular to the bottom plate 232 and is extended from edges, such as from four edges, of the bottom plate 232. The receiving container 230 includes a receiving space defined by the bottom plate 232 and the side wall 233. The receiving container 230 and the receiving space are configured and dimensioned such that the base substrate 210 and other components of the display apparatus may be received in the receiving space.

The bottom plate 232 of the receiving container 230 includes an opening 235. The opening 235 corresponds to the first connector 215, and has a shape and dimensions substantially corresponding to the shape of the first connector 215. As used herein, “corresponding” may be used to indicate one element corresponding in shape, profile, dimensions and/or positional placement relative to another element.

As illustrated in FIG. 1, when the first connector 215 is disposed adjacent to the edge of the base substrate 210, the opening 235 in the receiving container 230 is formed through the bottom plate 232 and adjacent to the side wall 233 of the receiving container 230. Alternatively, when the first connector 215 is connected at the central portion of the base substrate 210, the opening 235 of the receiving container 230 is formed through the bottom plate 232 at a central portion of bottom plate 232 and corresponding to the first connector 215. When the plurality of the first connector 215 are connected both at a position adjacent to the side of the base substrate 210 and to the central portion of the base substrate 210, a plurality of the openings 235 is formed through the bottom plate 232 of the receiving container 230, both adjacent to the side wall 233 and at the central portion of the bottom plate 232.

In an assembled state of the base substrate 210 and the receiving container 230, the first connector 215 of the base substrate 210 passes through the opening 235 in the receiving container 230, and is directly and electrically connected to the converter 240.

A cross-sectional shape of the first connector 215 may be substantially same as that of the opening 235. In the illustrated embodiment, the first connector 215 and opening 235 are configured such that the first connector 215 is relatively tightly connected to the opening 235, thereby more securely and strongly combining the first connector 215 and the opening 235 to each other.

In an exemplary embodiment, the opening 235 in the receiving container 230 may be formed with the receiving container 230 and substantially at the same time, such as using a die and mold for the receiving container 230. Alternatively, the opening 235 may be formed at a different time than the receiving container 230, such as using a press process on the bottom plate 232, after manufacturing the receiving container 230.

Referring again to FIG. 1, the converter 240 is disposed on an opposite side of the bottom plate of the receiving container 230 from the base substrate 210. The converter 240 provides a driving power to the base substrate 210 to control an on/off condition of the point light sources 220. In one exemplary embodiment, the converter 240 may be combined with the receiving container 230 using an insulating bolt. Advantageously, damage to a circuit is reduced or effectively prevented, because a heat transmitted to the receiving container 230 may be transmitted to the converter 240 through the insulating bolt.

The second connector 245 may be directly and electrically connected to the converter at an upper surface of the converter 240. The second connector 245 corresponds to the first connector 215 and the opening 235 of the receiving container 230.

As illustrated in FIG. 1, when the first connector 215 is connected adjacent to the side of the base substrate 210, and the opening 235 is formed through the bottom plate 232 adjacent to the side wall 233, the second connector 245 may be connected adjacent to a side of the converter 240. Alternatively, the second connector 245 may be connected at a central portion of the converter 240, or a plurality of the second connectors 245 may be connected both adjacent to the side of the converter 240 and at the central portion of the converter 240.

Advantageously, a manufacturing of the converter 240 may be simplified, and an assembly of the second connector 245 with the base substrate 210 and the receiving container 230, may be performed relatively easier. No further fastening elements may be needed to secure the base substrate 210 with the receiving container 230, since the combining of the first and second connectors 215 and 245 effectively fixes the base substrate 210, receiving container 230 and converter 240 together. Furthermore, the first connector 215 and the second connector 245 are separably fixed to each other, such that replacement or repair of elements of the backlight assembly 200 may be accomplished relatively easily. The second connector 245 is fixed extended substantially perpendicular to the converter 240, such as to be combined with the first connector 215 of the base substrate 210.

The first connector 215 connected to the base substrate 210 passes through the opening 235 of the receiving container 230, and is electrically connected to the second connector 245 electrically connected to the converter 240. Alternatively, the second connector 245 electrically connected to the converter 240 passes through the opening 235 of the receiving container 230, and is electrically connected to the first connector 215 connected to the base substrate 210. In addition, the first and second connectors 215 and 245 may be electrically connected with each other in the opening 235.

In an exemplary embodiment, the backlight assembly 200 may further include a diffusion plate 250 and/or optical sheets 260.

The diffusion plate 250 is disposed over and faces the base substrate 210. The light emitted from the point light sources 220 is incident into the diffusion plate 250 through a lower surface of the diffusion plate 250, and the diffusion plate 250 reflects and transmits the light.

In an exemplary embodiment, the optical sheets 260 may include, but are not limited to, a diffusion sheet 261 and prism sheets 262, such as to enhance efficiency of the light. For example, the diffusion sheet 261 disposed over the diffusion plate 250 diffuses the light that is emitted from the point light sources 220 and passes through the diffusion plate 250. The prism sheets 262 are disposed over the diffusion sheet 261, and condense the light diffused by the diffusion sheet 261 to provide the light to the display panel 300.

In an exemplary embodiment, a reflective sheet (not shown) may be disposed on the base substrate 210. After the reflective plate is attached on the base substrate 210, the point light sources 220 may be mounted on reflective plate, or may be extended through openings in the reflective plate and towards the display panel 300. The reflective sheet reduces or effectively prevents the light emitted from the point light sources 220 from leaking in a direction towards which the diffusion plate 250 is not disposed. In addition, the reflective sheet reflects the light that does not pass through the diffusion plate 250 and is reflected by the diffusion plate 250, toward the diffusion plate 250 again. Alternatively, a reflective layer coated on the base substrate 210 may be substituted for the reflective sheet.

The display panel 300 includes a first substrate 311, a second substrate 312, a liquid crystal layer (not shown), a data flexible printed circuit board (FPCB) 320, a gate FPCB 330, a data PCB 340 and a gate PCB 350. The display panel 300 is disposed over the backlight assembly 100, and displays images using the light emitted from the backlight assembly 100.

In an exemplary embodiment, the first substrate 311 may include a plurality of color filters on which red, green and blue pixels displaying color are formed. The second substrate 312 faces the first substrate 311. The second substrate 312 includes a plurality of pixel electrodes facing the color filters, thin-film transistors (“TFTs”) applying a driving voltage to each of the pixel electrodes, and a signal line driving the TFTs. The liquid crystal layer is disposed between the first and second substrates 311 and 312, and includes liquid crystal molecules. The liquid crystal molecules are arranged by an electric field applied thereto, to control light transmissivity.

The data and gate PCBs 340 and 350 are electrically connected to the second substrate 312, and provide a driving signal to the second substrate 312. In one exemplary embodiment, the gate PCB 350 may be omitted, such as by forming an additional signal line on the second substrate 312. The data and gate FPCBs 320 and 330 electrically connect the data and gate PCBs 340 and 350, respectively, to the second substrate 312, and provide the driving signal generated from the data and gate PCBs 340 and 350 to the second substrate 312. In an exemplary embodiment, the data and gate FPCBs 320 and 330 may be a tape carrier package (“TCP”) or a chip on film (“COF”).

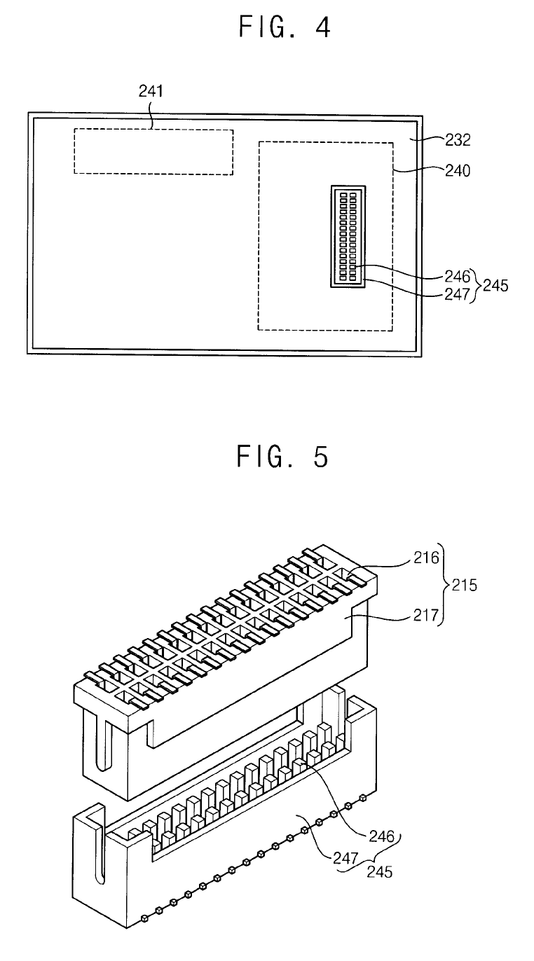

FIG. 3 is a plan view illustrating an exemplary embodiment of a base substrate in FIG. 1. FIG. 4 is a plan view illustrating an exemplary embodiment of a combined receiving container and a converter in FIG. 1. FIG. 5 is a perspective view illustrating an exemplary embodiment of first and second connectors of the display apparatus in FIG. 1.

Referring to FIGS. 3 and 4, as mentioned above, the first and second connectors 215 and 245 are electrically connected to the base substrate 210 and the converter 240, respectively, and correspond to each other.

Referring to FIGS. 3, 4 and 5, the first connector 215 includes a first connector terminal 216 and a first connector case 217. The first connector terminal 216 may include a plurality of pins receiving the driving power. In an exemplary embodiment, the pins of the first connector 215 may be formed in two lines and each line may have about 16 pins, so that the number of total pins may be about 32. A height (e.g., in a vertical direction of FIGS. 1 and 2) of the first connector case 217 may be greater than or less than a thickness of the bottom plate 232. In one exemplary embodiment, the height of the first connector case 217 may be between about 10 millimeters (mm) and about 12 millimeters (mm).

First end portions of the first connector 215 may be electrically connected to the base substrate 210 at the lower surface of the base substrate 210, such as via a soldering process. Alternatively, a connecting terminal (not shown) is formed on the lower surface of the base substrate 210, and the first end portions of the first connector 215 are inserted into the connecting terminal, such that the first end portions of the first connector 215 are connected to the base substrate 210 at the lower surface of the base substrate 210. In this case, second end portions of the first connector 215 are substantially perpendicular to the base substrate 210, and are combined with the second connector 245 of the converter 240.

The second connector 245 includes a second connector terminal 246 and a second connector case 247. The second connector terminal 246 includes a plurality of pins receiving the driving power. The number of the pins of the second connector terminal 246 may be substantially same as that of the first connector terminal 216. A height of the second connector case 247 may be greater than or less than the thickness of the bottom plate 232. In one exemplary embodiment, the height of the second connector case 247 may be between about 10 mm and about 12 mm.

First end portions of the second connector 245 may be electrically connected to the converter 240 at the lower surface of the converter 240, such as via the soldering process. Alternatively, the connecting terminal (not shown) is formed on the lower surface of the converter 240, and the first end portions of the second connector 245 are inserted into the connecting terminal, so that the first end portions of the second connector 245 is connected to the converter 240 at the lower surface of the converter 240. In this case, second end portions of the second connector 245 are substantially perpendicular to the converter 240, and are combined with the first connector 215 of the base substrate 210.

As illustrated in FIG. 5, each of the first connector terminals 216 of the first connector 215 has a groove shape, and each of the second connector terminals 246 of the second connector 245 has a protrusion shape. Alternatively, each of the first connector terminals 216 of the first connector 215 may have the protrusion shape, and each of the second connector terminals 246 of the second connector 245 may have the groove shape, so that each of the first connector terminals 216 and each of the second connector terminals 246 are connected with each other. Referring to FIGS. 1, 2 and 4, the backlight assembly 200 is disposed under the receiving container 230, and may further include a control part 241 electrically connected to the converter 240. The control part 241 controls the converter 240. In one exemplary embodiment, the control part 241 may be disposed on the opposite surface of the bottom plate of the receiving container 230 and secured at a rear of the receiving container 230, such as using the insulating bolt.

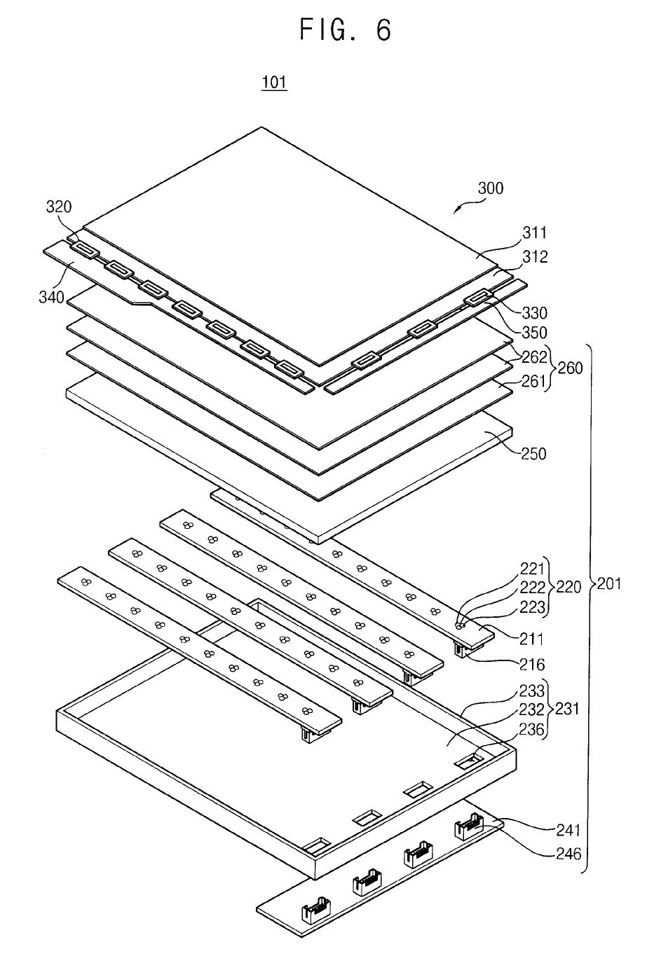

FIG. 6 is an exploded perspective view illustrating another exemplary embodiment of a display apparatus 101 according to another example embodiment of the present invention.

The display apparatus 101 according of FIG. 6 is substantially same as the display apparatus 100 illustrated in FIGS. 1 to 5, except for a base substrate 211, a receiving container 231 and a converter 241. Thus, the same reference numerals will be used to refer to the same or like parts as those described in the previous exemplary embodiments illustrated in FIGS. 1 to 5, and any further repetitive explanation concerning the above elements will be omitted.

Referring to FIG. 6, the display apparatus 101 includes a backlight assembly 201 and a display panel 300.

The backlight assembly 201 includes a plurality of the base substrate 211, a plurality of point light sources 220, the receiving container 231 and the converter 241.

The base substrates 211 may be disposed substantially parallel with each other, are extended in a first direction (e.g., a longitudinal direction of the receiving container 231), and are arranged along a second direction (e.g., a transverse direction of the receiving container 231). Alternatively, the plurality of base substrates 211 may extend in a transverse direction and be arranged along the longitudinal direction.

The point light sources 220 are mounted on each of the base substrates 211. A first connector 216 is directly and electrically connected to the base substrate 211 at a lower surface of each of the base substrates 211. In one exemplary embodiment, each of the base substrates 211 may be the PCB. Where the base substrate 211 is a PCB, the control circuit that controls the point light sources 220 may be printed on the base substrate 211.

As illustrated in FIG. 6, each of an individual one the first connector 216 is directly and electrically connected to the base substrate 211 at the lower surface of each of the base substrates 211. Each of the first connectors 216 is connected adjacent to an edge (e.g., side) of each of the base substrates 211 at a first end of the base substrate 211. In this case, a structure of the base substrates 211 may be simplified, and an assembly of the base substrates 211 with the receiving container 231 and the converter 241 may be a relatively easier process. Alternatively, the first connector 216 may be connected at a central portion of each of the base substrates 211, or the first connector 216 may be connected both adjacent to the side of, and at the central portion of each of the base substrates 211. In exemplary embodiments, more than two first connectors 216 may be connected to each of the base substrates 211 at the lower surface of each of the base substrates 211 at any of a number of locations as is suitable for the purpose described herein.

The first connectors 216 extend and are fixed substantially perpendicular to the base substrates 211, such that the first connectors 216 may be combined with the second connectors 246 of the converter 241.

The point light sources 220 may be mounted on each of the base substrates 211 and arranged in a single line, or a plurality of lines, such as along the longitudinal direction of the base substrates 211. In exemplary embodiments, a number of the point light sources 220 and an arrangement distance between the point light sources 220 on the base substrates may be determined by the size and the usage of the base substrates 211 in the display apparatus 101. The number of point light sources 220 may be the same for each of the base substrates 211, or the number may be unequal.

In the illustrated embodiment of FIG. 6, the point light sources 220 are individually controlled by each of the base substrates 211 on which the point light sources 220 are mounted. Advantageously, a local driving of the point light sources 220, such as with a local dimming circuit, may be possible. In addition, when some of the point light sources 220 are malfunctioned, the point light sources 220 and/or the base substrate 211 may be repaired or replaced relatively easy.

The receiving container 231 includes a bottom plate 232 and a side wall 233. The bottom plate 232 faces the lower surface of the base substrate 211. The bottom plate 232 of the receiving container 231 includes a plurality of openings 236. Each of the openings 236 corresponds to the first connector 216, and has a shape corresponding to the shape of the first connector 216.

When the first connectors 216 are connected adjacent to the side of each of the base substrates 211, the openings 236 are formed adjacent to the side wall 233 of the receiving container 231. Alternatively, the openings 236 may be formed at a central portion of the bottom plate 232 of the receiving container 231, or the openings 236 may be formed both adjacent to the side wall 233 and at the central portion of the bottom plate 232 base on the positional placement of the plurality of first connectors 216 on their respective base substrate 211.

The first connectors 216 pass through the openings 236 and are directly and electrically connected to the converter 241.

The converter 214 is disposed on an opposite side of the bottom plate of the receiving container 231 from the base substrate, and provides the driving power to the base substrates 211, such as to control the point light sources 220.

The second connectors 246 are directly and electrically connected to the converter 241 at an upper surface of the converter 241. The second connectors 246 correspond to the first connectors 216 and the openings 236 of the receiving container 231.

When the first connectors 216 are connected adjacent to the side of each of the base substrates 211 and the openings 236 are formed adjacent to the side wall 233 of the receiving container 231, the second connectors 246 are connected adjacent to a side of the converter 241. Alternatively, the second connectors 246 may be connected at a central portion of the converter 241, or the second connectors 246 may be connected both adjacent to the side of the converter 241 and at the central portion of the converter 241 based on the positional placement of the first connectors 216 and/or the openings 236.

The second connectors 246 extend and are fixed substantially perpendicular to the converter 241, such as to be combined with a respective first connector 216 of the base substrate 211.

In combining the base substrates 211, the receiving container 231 and the converter 241, each of the first connectors 216 connected to the base substrate 211 passes through each of the openings 236 of the receiving container 231 (e.g., toward a rear of the receiving container 231), and is electrically connected to each of the second connectors 246 connected to the converter 241. Alternatively, each of the second connectors 246 connected to the converter 241 passes through each of the openings 236 of the receiving container 231 (e.g., toward a front of the receiving container 231, or toward the display panel 330), and is electrically connected to each of the first connectors 216 connected to the base substrate 211. Each of the first connectors 216 and each of the second connectors 246 are electrically connected in each of the openings 236.

As in the illustrated embodiments, the PCB is directly connected to the converter through the connector, without using a connecting line. Advantageously, a manufacturing process and external appearances of the display apparatus may be simplified, and manufacturing costs may be decreased.

In addition, since the PCB is connected to the converter without a connecting line, when the PCB or the converter is malfunctioned, the PCB and/or the converter may be advantageously repaired or replaced relatively easy, and the durability of the display apparatus may be enhanced.

Having described the example embodiments of the present invention and its advantage, it is noted that various changes, substitutions and alterations can be made herein without departing from the spirit and scope of the invention as defined by appended claims.

What is claimed is:

1. A backlight assembly comprising:
a base substrate including a first connector electrically connected to the base substrate at a lower surface of the base substrate;
a plurality of point light sources disposed on the base substrate;
a receiving container including a side wall and a bottom plate, and receiving the base substrate, the bottom plate facing the lower surface of the base substrate and including an opening into which the first connector of the base substrate is inserted; and
a converter disposed on an opposite side of the bottom plate of the receiving container from the base substrate and including a second connector electrically connected to the converter at an upper surface of the converter, the second connector being separably connected to the first connector.

2. The backlight assembly of claim 1, wherein the first connector of the base substrate is directly and electrically connected to the second connector of the converter through the opening of the receiving container.

3. The backlight assembly of claim 2, wherein the opening is disposed at a side of the bottom plate and adjacent to the side wall of the receiving container.

4. The backlight assembly of claim 3, wherein a height of the first connector, of the second connector, or of the first and second connectors is between about 10 millimeters (mm) and about 12 millimeters (mm).

5. The backlight assembly of claim 1, wherein the point light sources comprise light emitting diodes (“LEDs”) emitting white light.

6. The backlight assembly of claim 1, wherein the point light sources comprise at least one of a green LED, a blue LED, and a red LED.

7. The backlight assembly of claim 5, wherein the green LED, blue LED, and red LED are integrated into one chip.

8. The backlight assembly of claim 1, further comprising a control part disposed on the opposite surface of the bottom plate of the receiving container, and electrically connected to the converter, the electrically connected control part controlling the converter.

9. A backlight assembly comprising:
a plurality of base substrates arranged substantially parallel to each other, each of the base substrates including a first connector electrically connected to the base substrate at a lower surface of the base substrate;
a plurality of point light sources disposed on each of the base substrates;
a receiving container including a side wall and a bottom plate, and receiving the base substrates, the bottom plate facing the lower surfaces of the base substrates, including a plurality of openings, each of the openings corresponding to a first connector; and
a converter disposed on an opposite side of the bottom plate of the receiving container from the base substrates and including a plurality of second connectors electrically connected to the converter at an upper surface of the converter, each of the second connectors corresponding to a first connectors and an opening.

10. The backlight assembly of claim 9, wherein each of the first connectors passes through the opening corresponding to the first connector, and is directly and electrically connected to the second connector.

11. The backlight assembly of claim 10, wherein the point light sources comprise light emitting diodes (“LEDs”) emitting white light.

12. A display apparatus comprising:
a backlight assembly including:
a base substrate including a first connector electrically connected to the base substrate at a lower surface of the base substrate;
a receiving container and including a side wall and a bottom plate, the bottom plate facing the lower surface of the base substrate and including an opening corresponding to the first connector; and
a converter disposed on an opposite side of the bottom plate of the receiving container from the base substrate, and including a second connector electrically connected to the converter at an upper surface of the converter, the second connector corresponding to the first connector and the opening; and
a display panel disposed facing an upper surface of the base substrate of the backlight assembly, the display panel displaying images using light passing through the backlight assembly.

13. The display apparatus of claim 12, wherein the first connector passes through the opening of the receiving container, and is directly and electrically connected to the second connector.

14. The display apparatus of claim 13, further comprising:
a plurality of point light sources disposed on the base substrate.

15. The display apparatus of claim 13, further comprising a plurality of base substrates, each of the base substrates including the first connector;
a plurality of converters, each of the converter including the second connector; and
a plurality of openings in the receiving container,
wherein each of the first connectors passes through an opening corresponding to the first connector, and is directly and electrically connected to the second connector corresponding to the opening.

16. A method for manufacturing a backlight assembly, the method comprising:
electrically connecting a first connector to a base substrate at a lower surface of the base substrate, the base substrate including a plurality of point light sources is disposed on an upper surface of the base substrate;
disposing a receiving container including a side wall, and a bottom plate including an opening, the bottom plate facing the lower surface of the base substrate, the opening corresponding to the first connector of the base substrate;
directly and electrically connecting a second connector to an upper surface of a converter; and
disposing the converter on an opposite side of the bottom plate of the receiving container from the base substrates, the second connector corresponding to the first connector of the base substrate and the opening of the receiving container.

17. The method of claim 16, further comprising directly and electrically connecting the first connector to the second connector while the first connector and the second connector are both disposed through the opening.

18. The method of claim 16, wherein the opening is formed through a press process.

19. The method of claim 16, further comprising:
electrically connecting a plurality of first connectors to a plurality of base substrates at lower surfaces of the plurality of base substrates, respectively, each of the base substrates including a plurality of point light sources disposed on an upper surface of the base substrate; and
directly and electrically connecting a plurality of second connectors to a plurality of converters at upper surfaces of the plurality of converters, respectively, each of the second connectors corresponding to a first connector of the base substrate and an opening of the receiving container.

20. The method of claim 19, wherein each pair of corresponding first and second connectors are separably connected.
